(19) United States
(12) Patent Application Publication
(10) Pub. No.: US 2026/0249777 A1
(43) Pub. Date: Aug. 27, 2026

(54) COVER PANEL SYSTEM FOR VEHICULAR LIGHTING AND CAMERA-BASED VISION SYSTEM

(71) Applicant: Magna Mirrors of America, Inc., Holland, MI (US)

(72) Inventor: Darren Navin, Newmarket (CA)

(21) Appl. No.: 19/544,111

(22) Filed: Feb. 19, 2026

Related U.S. Application Data
(60) Provisional application No. 63/761,663, filed on Feb. 21, 2025.

(51) Int. Cl. B60Q 1/04; B60Q 1/26; B60R 1/26; B62D 25/12; E05B 83/24; E05D 11/10

(52) U.S. Cl. CPC B60Q 1/0458; B60Q 1/0466; B60Q 1/2642; B60R 1/26; B62D 25/12; E05B 83/243; E05D 11/1057; B60R 2300/105; B60R 2300/8046

(57) ABSTRACT

A vehicular cover panel opening system includes a hinge assembly configured to pivotably mount a cover panel at a compartment area of a vehicle. The cover panel is movable between a closed position, an opened position and a partially opened position. A latch assembly is configured to secure the cover panel in the closed position and release the cover panel to move from the closed position or the partially opened position. The system operates the latch assembly to release the cover panel and the cover panel moves from the closed position to the partially opened position. With the cover panel in the closed position, the cover panel extends over and along a lighting device of the vehicle to conceal the lighting device. With the cover panel in the partially opened position, light emitted by the lighting device is viewable exterior the vehicle.

### CROSS REFERENCE TO RELATED APPLICATION

The present application claims the filing benefit of U.S. provisional application Ser. No. 63/761,663, filed Feb. 21, 2025, which is hereby incorporated herein by reference in its entirety.

### FIELD OF THE INVENTION

The present disclosure relates generally to lighting and camera-based mirror systems for a vehicle. More specifically, the present disclosure is directed to a cover panel or hood system, including a headlight and camera-based exterior rearview mirror system, for a vehicle.

### BACKGROUND OF THE INVENTION

Vehicles have headlights, also referred to as headlamps, for illuminating a front environment of the vehicle and side mirrors or exterior rearview mirrors to allow a driver to view an environment along and behind opposite sides of the vehicle. Although current headlight and side mirror systems generally function as intended, they come with various drawbacks. For example, headlights and side mirrors are typically large and in constant view from outside the vehicle. The large size can be problematic from an aesthetic, stylistic appearance standpoint, and further, create drag while the vehicle is moving, thereby having a negative effect on fuel economy. Further yet, side mirrors can present problems when driving and/or parking within tight spaces, such as driving next to other vehicles or parking in a narrow garage, for example, and thus, can become damaged as a result. Further, side mirrors can fail to eliminate blind spots, and headlights can become worn over time, with the covers or lenses becoming cloudy due to constant exposure to environmental elements and natural light wavelengths. Additionally, the headlights and side mirrors are typically prone to ice and snow buildup, thereby requiring removal of the ice and/or snow prior to driving the vehicle. Of course, if the ice and/or snow is not removed, the function of the headlights and side mirrors will be compromised, thereby complicating the ability of a driver to see.

### SUMMARY OF THE INVENTION

This section provides a general summary of the inventive solutions associated with the present disclosure. Accordingly, this section is not intended to be interpreted as a comprehensive and exhaustive listing of all features, aspects, objectives and/or advantages associated with the inventive solutions which are further described and illustrated in the following detailed description and the appended drawings.

It is an objective of the present disclosure to provide a hood and viewing system that addresses the drawbacks discussed above.

In accordance with an aspect of the disclosure, a hood and viewing system for a vehicle includes a controller and a hood movable in response to a signal from the controller from a fully closed position, whereat a ratchet of a latch assembly is in a striker capture position, whereat the ratchet retains a striker fixed to the hood in a fully captured position, to a partially open position, whereat the striker remains captured by the latch assembly. The hood and viewing system further includes at least one of a headlamp system and a side imaging system. The headlamp system includes at least one headlamp, with the headlamp system being concealed from view beneath the hood when the hood is in the fully closed position, and the headlamp system being exposed to allow the at least one headlamp to illuminate an environment in front of the vehicle when the hood is in the partially open position. The side imaging system includes a pair of side cameras, with the side imaging system being concealed from view beneath the hood when the hood is in the fully closed position, and the side imaging system being exposed to allow the pair of side cameras to present views of a side environment along opposite sides of the vehicle to a driver when the hood is in the partially open position.

According to another aspect of the disclosure, a vehicular forward cover panel opening system includes a forward cover panel disposed at a forward compartment area of a vehicle equipped with the vehicular forward cover panel opening system. The forward cover panel is movable between (i) a closed position where the forward cover panel covers an opening of the forward compartment area of the vehicle, (ii) an opened position where the forward cover panel is moved away from the opening of the forward compartment area to allow access to the forward compartment area and (iii) a partially opened position between the closed position and the opened position. With the forward cover panel in the closed position, a ratchet of a latch assembly is in a striker capture position where theratchet retains a striker fixed to the forward cover panel. With the forward cover panel in the partially opened position, the ratchet retains the striker fixed to the forward cover panel. The hood is movable between at least the closed position and the partially opened position in response to a signal from a controller of the system. With the forward cover panel in the closed position, the forward cover panel extends over and along a headlamp of the vehicle to conceal the headlamp from view beneath the forward cover panel. With the forward cover panel in the partially opened position, and when the headlamp is electrically operated to emit light, the headlamp is exposed and light emitted by the headlamp illuminates an environment forward of the vehicle.

Optionally, the forward cover panel further conceals a driver-side camera disposed at the vehicle and a passenger-side camera disposed at the vehicle. That is, with the forward cover panel in the closed position, the driver-side camera and the passenger- side camera are concealed from view beneath the forward cover panel. With the forward cover panel in the partially opened position, the driver-side camera is exposed and views exterior of the vehicle and at least rearward of the vehicle and along a driver side of the vehicle and the passenger-side camera is exposed and views exterior of the vehicle and at least rearward of the vehicle and along a passenger side of the vehicle. Image data captured by the side cameras may be used to display video images at an interior rearview mirror assembly or A-pillar display devices.

Yet another aspect provides a vehicular cover panel opening system that includes a hinge assembly configured to pivotably mount a cover panel at a compartment area of a vehicle equipped with the vehicular cover panel opening system. With the cover panel mounted at the compartment area of the vehicle, the cover panel is movable between a closed position, an opened position, and a partially opened position between the closed and opened positions. In the closed position, the cover panel covers an opening of the compartment area of the vehicle. In the opened position, the cover panel is moved away from the opening to allow access to the compartment area. With the cover panel mounted at the compartment area of the vehicle, a latch assembly is configured to secure the cover panel in the closed position and release the cover panel to allow the cover panel to move from the closed position. With the cover panel mounted at the compartment area of the vehicle, and with the cover panel in the closed position, the vehicular cover panel opening system operates the latch assembly to release the cover panel and the cover panel moves from the closed position to the partially opened position. The vehicle includes at least one lighting device. With the cover panel mounted at the compartment area of the vehicle, and with the cover panel in the closed position, the cover panel extends over and along the at least one lighting device to conceal the at least one lighting device from view beneath the cover panel. With the cover panel mounted at the compartment area of the vehicle, and with the cover panel in the partially opened position, and when the at least one lighting device is electrically operated to emit light, the at least one lighting device is exposed and light emitted by the at least one lighting device is viewable exterior the vehicle. This aspect may include one or more of the following optional features.

In some implementations, the latch assembly includes a ratchet disposed at a body of the vehicle. With the cover panel mounted at the compartment area of the vehicle, and with the cover panel in the closed position, the ratchet is in a striker capture position where the ratchet retains a striker fixed to the cover panel. With the cover panel in the partially opened position, the ratchet retains the striker fixed to the forward cover panel. With the cover panel in the opened position, the ratchet releases the striker to allow the cover panel to move relative to the body of the vehicle.

In some examples, with the cover panel mounted at the compartment area of the vehicle, the vehicular cover panel opening system operates to move the cover panel from the closed position to the partially opened position in response to an operating state change of the vehicle. In further examples, the operating state change of the vehicle includes one selected from the group consisting of (i) an operation of a lighting system of the vehicle, (ii) an operation of an internal combustion engine of the vehicle, (iii) an operation of an electric propulsion system of the vehicle and (iv) an operation of a transmission of the vehicle.

In some aspects, the hinge assembly includes a hinge that, with the cover panel mounted at the compartment area of the vehicle, is mounted to the cover panel and a body of the vehicle. The hinge is adjustable between (i) a collapsed state corresponding to the cover panel being in the closed position, (ii) an expanded state corresponding to the cover panel being in the opened position and (iii) a deployed state corresponding to the cover panel being in the partially opened position. In further aspects, with the cover panel mounted at the compartment area of the vehicle, and with the hinge in the collapsed state and the cover panel in the closed position, the latch assembly secures the cover panel relative to the body of the vehicle. With the hinge in the expanded state and the cover panel in the opened position, the latch assembly releases the cover panel to allow the cover panel to move relative to the body of the vehicle. With the hinge in the deployed state and the cover panel in the partially opened position, the latch assembly secures the cover panel relative to the body of the vehicle. In further aspects, the hinge assembly includes a pair of hinges that, with the cover panel mounted at the compartment area of the vehicle, each mount to the cover panel and the body of the vehicle. In further aspects, the latch assembly is disposed at a first side portion of the cover panel. The hinge is disposed at a second side portion of the cover panel opposite the first side portion. With the cover panel mounted at the compartment area of the vehicle, the latch assembly and the first side portion of the cover panel are disposed at a front end region of the body of the vehicle and the hinge and the second side portion of the cover panel are disposed at the body of the vehicle and adjacent to a windshield of the vehicle. In even further aspects, with the cover panel mounted at the compartment area of the vehicle, and when the hinge is adjusted between the collapsed state and the deployed state, the cover panel translates relative to the body of the vehicle. When the hinge is adjusted between the deployed state and the expanded state, the cover panel pivots relative to the body of the vehicle. In further aspects, the hinge assembly includes an electrically operable actuator that operates to adjust the hinge between the collapsed state, the deployed state, and the expanded state.

In some implementations, the latch assembly includes an electrically operable actuator that operates to move the cover panel between the closed position, the partially opened position, and the opened position.

In some examples, the vehicle includes a sensor. With the cover panel mounted at the compartment area of the vehicle, and with the cover panel in the closed position, the sensor is concealed from view beneath the cover panel. With the cover panel mounted at the compartment area of the vehicle, and with the cover panel in the partially opened position, the sensor is exposed and senses exterior of the vehicle. In further examples, with the cover panel mounted at the compartment area of the vehicle, and with the cover panel in the partially opened position, a gap is formed between the cover panel and a body of the vehicle and the sensor senses exterior of the vehicle through the gap. In even further examples, the sensor is disposed at an extendable member that, with the cover panel mounted at the compartment area of the vehicle, and with the cover panel in the partially opened position, extends through the gap. In further examples, the sensor includes a driver-side camera and a passenger-side camera. With the cover panel mounted at the compartment area of the vehicle, and with the cover panel in the closed position, the driver-side camera and the passenger-side camera are concealed from view beneath the cover panel. With the cover panel mounted at the compartment area of the vehicle, and with the cover panel in the partially opened position, (i) the driver-side camera is exposed and views exterior of the vehicle and at least rearward of the vehicle and along a driver side of the vehicle and (ii) the passenger-side camera is exposed and views exterior of the vehicle and at least rearward of the vehicle and along a passenger side of the vehicle. In even further examples, driver-side video images representative of the view rearward of the vehicle and along the driver side of the vehicle are generated based on image data captured by the driver-side camera. Passenger-side video images representative of the view rearward of the vehicle and along the passenger side of the vehicle are generated based on image data captured by the passenger-side camera. In some even further examples, the driver-side video images and the passenger-side video images are displayed at a video display screen of an interior rearview mirror assembly of the vehicle. In other even further examples, the driver-side video images are displayed at a driver-side display device disposed at a driver-side A-pillar of the vehicle and the passenger-side video images are displayed at a passenger-side display device disposed at a passenger-side A-pillar of the vehicle. In further examples, the driver-side camera is disposed at a driver-side wing that is pivotably disposed at the vehicle. The driver-side camera is disposed at a passenger-side wing that is pivotably disposed at the vehicle. With the cover panel mounted at the compartment area of the vehicle, and with the cover panel in the closed position, the driver-side wing and the passenger-side wing are in a folded position, where the driver-side wing is pivoted in toward the driver side of the vehicle and the passenger-side wing is pivoted in toward the passenger side of the vehicle. With the cover panel in the partially opened position, the driver-side wing and the passenger-side wing are in an extended position, where the driver-side wing is pivoted out from the driver side of the vehicle and the passenger-side wing is pivoted out from the passenger side of the vehicle. In further examples, the driver-side camera is disposed at a driver-side arm that is movably disposed at the vehicle. The driver-side camera is disposed at a passenger-side arm that is movably disposed at the vehicle. With the cover panel mounted at the compartment area of the vehicle, and with the cover panel in the closed position, the driver-side arm and the passenger-side arm are in a retracted position, where the driver- side arm is moved in toward the driver side of the vehicle and the passenger-side arm is moved in toward the passenger side of the vehicle. With the cover panel in the partially opened position, the driver-side arm and the passenger-side arm are in an extended position, where the driver-side arm is telescopically extended out from the driver side of the vehicle and the passenger-side arm is telescopically extended out from the passenger side of the vehicle.

In some aspects, the at least one lighting device includes at least one of (i) a daylight running lamp, (ii) a high beam lamp, (iii) a low beam lamp, (iv) a turn signal indicator lamp, (v) a brake light, (vi) a reverse light and (vii) an aesthetic light.

In some implementations, the cover panel includes a seal that, with the cover panel mounted at the compartment area of the vehicle, and with the cover panel in the opened position or in the partially opened position, seals the opening of the compartment area.

In some examples, the cover panel includes a vent. With the cover panel mounted at the compartment area of the vehicle, and with the cover panel in the partially opened position and as the vehicle travels in a forward direction of travel, airflow that passes between the cover panel and a body of the vehicle is directed through the vent and upward away from the cover panel. In further examples, a downward force is applied at a front portion of the vehicle as the airflow is directed through the vent and upward away from the cover panel.

In some implementations, the vehicular cover panel opening system includes a controller disposed at the vehicle. With the cover panel mounted at the compartment area of the vehicle, the cover panel is movable between at least the closed position and the partially opened position in response to a signal from the controller. In further implementations, with the cover panel mounted at the compartment area of the vehicle, the controller transmits the signal to move the cover panel from the closed position to the partially opened position upon vehicle start up. In other further implementations, with the cover panel mounted at the compartment area of the vehicle, the controller transmits the signal to move the cover panel from the closed position to the partially opened position in response to a user input. In even further implementations, the user input is associated with one of (i) a propulsion system of the vehicle being adjusted to a drive state, (ii) a key fob of the vehicle, and (iii) the vehicle being started.

In some examples, the compartment area includes one of an engine bay of the vehicle and a forward cargo area of the vehicle.

These and other objects, advantages, purposes and features of the present invention will become apparent upon review of the following specification in conjunction with the drawings.

### BRIEF DESCRIPTION OF THE DRAWINGS

FIG. 1A is a front view of a vehicle having a hood or forward cover panel in a fully closed position, where a headlamp system of the vehicle and a viewing system of the vehicle are concealed beneath the hood in the closed position ;

FIG. 1 B is a front view of the vehicle, with the hood raised to a partially opened position, where one or more headlamps of the headlamp system and side cameras of a side imaging system of the viewing system are exposed to facilitate viewing by a driver of an environment in front of the vehicle and of opposite side environments along and behind opposite sides of the vehicle;

FIG. 2A is a side view of the vehicle with the hood in the fully closed position and concealing the headlamp system and side imaging system of the viewing system;

FIG. 2B is another side view of the vehicle, further illustrating the viewing system concealed beneath the hood while in the fully closed position;

FIG. 3 is a side view of the vehicle with the hood in the partially opened position and exposing the headlamp system and side imaging system of the viewing system for use;

FIG. 4 is a perspective view of the vehicle with the side imaging system of the viewing system arranged in operable communication with at least one of a rearview mirror within a passenger cabin of the vehicle and a viewing screen along an A-pillar of the vehicle;

FIG. 5 is a perspective view of the vehicle showing air flow while the hood is in the partially opened position;

FIG. 6 is a perspective view of the vehicle, with a mechanism for raising the hood to the partially opened position and a combination headlamp system and side imaging system; and

FIG. 7 is a perspective view of an underside of the hood.

### DESCRIPTION OF THE PREFERRED EMBODIMENTS

Example embodiments of a hood and viewing system of a vehicle will now be described more fully with reference to the accompanying drawings. To this end, the example embodiments of the hood and viewing system are provided so that the disclosure will be thorough and will fully convey its intended scope to those who are skilled in the art. Accordingly, numerous specific details are set forth such as examples of specific components, devices, and methods, to provide a thorough understanding of particular embodiments of the present disclosure. However, it will be apparently to those skilled in the art that specific details need not be employed, that the example embodiments may be embodied in many different forms, and that the example embodiments should not be construed to limit the scope of the present disclosure. In some parts of the example embodiments, well-known processes, well-known device structures, and well-known technologies are not described in detail.

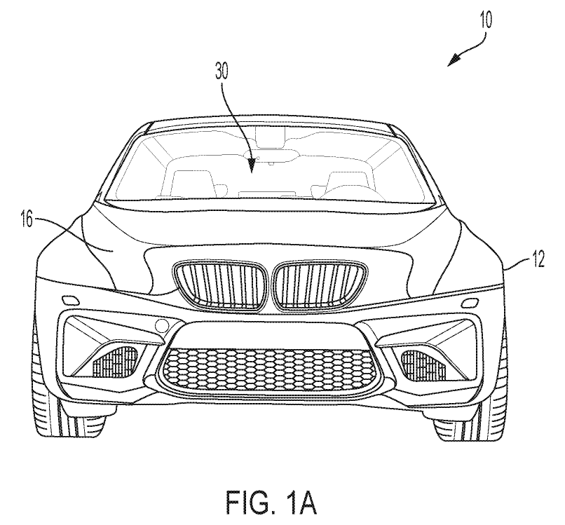

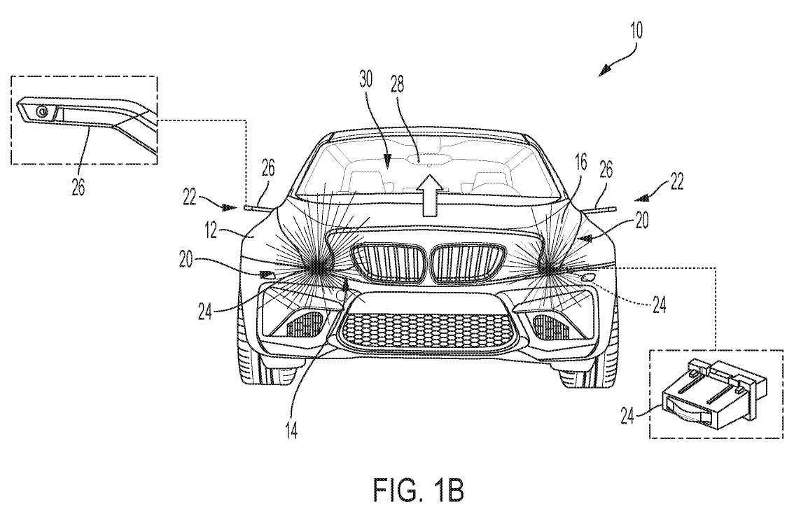

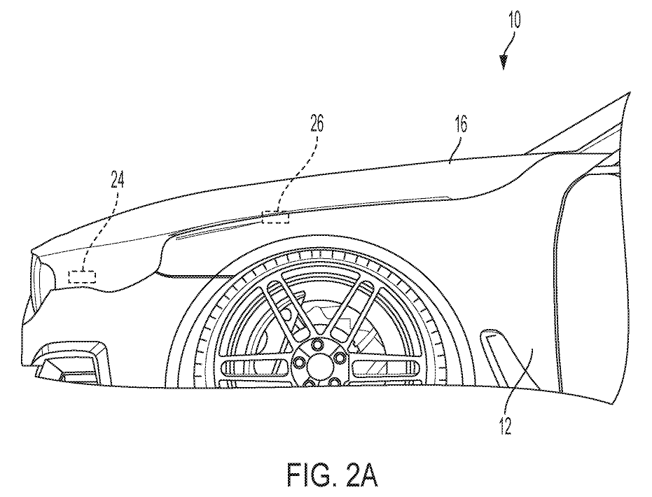

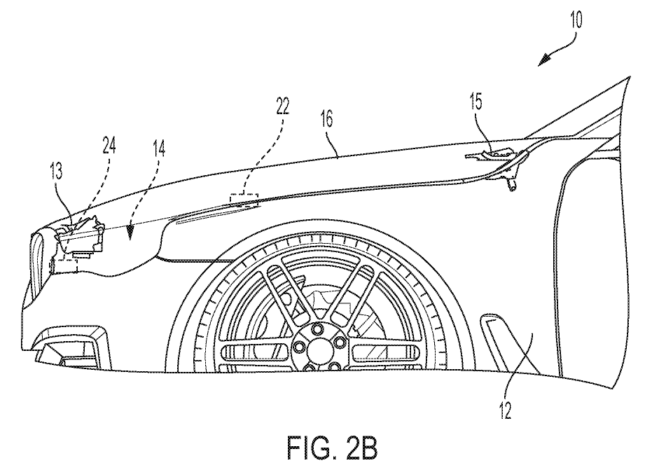

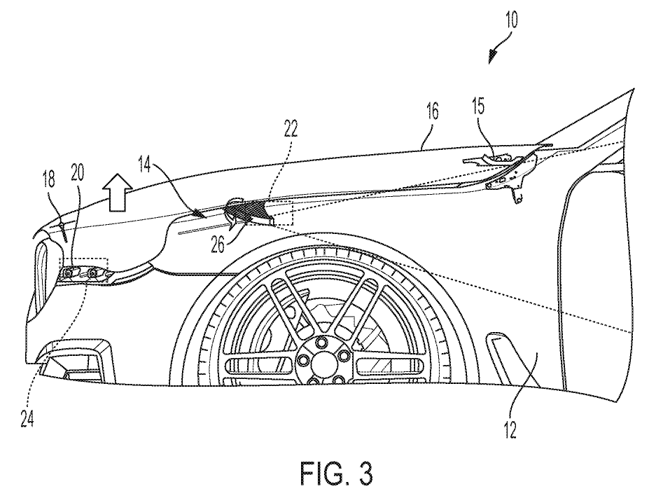

Referring now to the drawings and the illustrative embodiments depicted therein, a vehicle 10 has a body 12 defining a front compartment 14, such as an engine compartment or a storage compartment, otherwise known as a front trunk, sometimes referred to as "frunk", not having an engine but located in the forward region of the vehicle (FIGS. 1A-4). A closure panel or front hood or hood 16 is pivotably or movably mounted to the body 12 for movement relative to the front compartment 14 between a fully-closed position (FIGS. 1A, 2A and 2B), and a partially opened or pop-up position (FIGS. 1B, 3 and 4). In the illustrated example, the closure panel 16 is a hood provided at the front of the vehicle 10 for enclosing an engine bay or a frunk, also referred to as stowage compartment. In other examples, the cover panel may include a tailgate, a liftgate, or other type of closure panel of the vehicle 10. The hood 16 may be manually released from within a passenger compartment of the vehicle 10, which functions to actuate a latch release mechanism associated with a latching arrangement, such as a closure latch assembly 13, for releasing the hood 16 and permitting subsequent movement of the hood 16 to its partially opened, pop-up position or to a fully-opened position. The closure latch assembly 13 may be disposed at or near the front end of the vehicle 10. The closure latch assembly 13 can be secured to a structural portion of the vehicle body 12 adjacent to the front compartment 14 and is configured to releasably engage a striker 18 mounted in fixed relation to an underside of the hood 16. For example, the latch assembly 13 is disposed at or near the front end of the vehicle body and the striker 18 is disposed at or near a first end region or front end region of the hood 16. As discussed further below, the vehicle 10 includes a hood and viewing system having at least one of a lighting device or headlamp system 20 and a sensor or side viewing system or side imaging system 22.

The closure latch assembly 13 may be configured as a front hood latch having an actuator or motor to release the striker from a primary striker capture position to a secondary striker capture position as part of a power release operation or soft open/present function of the latch assembly 13; to fully release the striker 18; and also to return the striker 18 from a secondary striker capture position to a primary striker capture position as part of a cinch or soft close operation. For example, the closure latch assembly may utilize characteristics of the latches described in U.S. Patent Application Pub. No. US- 2021-0370864, which is incorporated herein by reference in its entirety.

In other words, the vehicle 10 includes the hood or front body panel 16 disposed at a forward portion of the vehicle 10 and extending at least partially over the front compartment 14 of the vehicle 10 (e.g., the engine compartment or front storage compartment). The hood 16 is movable at least between a closed or fully closed position, where the hood 16 extends over and along the front compartment 14 to cover and/or seal the front compartment 14, to a partially opened or pop-up position, where the hood 16 is moved from the closed position away from the front compartment 14, and to a fully opened position, where the hood 16 is moved further from the closed position away from the front compartment 14 to provide access to the front compartment 14.

A hinge arrangement, which may include a pair of hinges connected to the hood 16 and to the vehicle body 12 facilitate such motion of the hood 16. Optionally, a powered actuator having a motor may be configured to move the front closure panel from a closed position of the hinge to a deployed, or active pedestrian position, and also back to the closed position from the deployed position. The hinge 15 may have a collapsed state corresponding to the closed position of the hood 16, an expanded state corresponding to the opened position of the hood 16, and a deployed state corresponding to the partially opened position of the hood 16. The actuator may be operable to adjust the state of the hinge 15 between the collapsed, deployed and expanded states to move the hood 16 between positions. In the illustrated example of FIG. 2B, the hinges 15 are disposed at or near a second end region or rear end of the hood 16 and adjacent the windshield rearward of the latch assembly 13. The hinge and actuator may utilize characteristics of the hinges and actuators described in U.S. Patent Application Pub. No. US-2023-0356688, which is incorporated herein by reference in its entirety.

The striker 18 and latch may retain the hood 16 in the partially opened position when initially moved from the closed position, such that the front compartment 14 is not accessible in the partially opened position. The user may access the striker 18 and latch with the hood 16 in the partially opened position for moving the hood 16 to the fully opened position. Moreover, the front compartment 14 may be at least partially covered and/or sealed with the hood 16 in the partially opened position, such as to prevent moisture and debris from moving into the front compartment 14. The hood 16 may be pivotably mounted to the body 12 of the vehicle 10, such that the hood 16 pivots relative to the body 12 between the closed position and the fully opened position (e.g., in a clockwise direction in FIG. 2A). Optionally, the hood 16 may move axially (e.g., in a substantially vertical direction) when moved between the closed position and the partially opened position, such that the hood 16 translates vertically away from the body 12 when moved to the partially opened position. That is, the hood 16 may translate away from the vehicle body when the hinge 15 is adjusted between the collapsed state and the deployed state, and the hood 16 may pivot away from the vehicle body and toward the windshield of the vehicle when the hinge 15 is adjusted from the deployed state the expanded state. As shown in FIG. 1B, with the hood 16 moved to the partially opened position, the hood 16 does not obstruct a driver's view of the environment in front of the vehicle 10.

The hood and viewing system is configured to cooperate in operable communication with the closure latch assembly and a control unit (e.g., an electronic control unit (ECU) having electronic circuitry and associated software for at least partially controlling operation of the hood and viewing system), with a power release function (e.g., automatically actuatable via a sensor/controller system) to automatically move the hood 16 to the pop-up position upon the vehicle 10 being started and/or upon the vehicle 10 being placed in a drive gear, or upon a selectively actuated feature activated by a driver, such as a button or switch, by way of example and without limitation. In other words, the hood 16 may be moved from the closed position to the partially opened position in response to an operating state change of the vehicle. For example, the hood 16 may be moved to the partially opened position based on an operation of the lighting system of the vehicle (i.e., the lighting system or headlamp system being operated from an off state to an on state). Optionally, the hood 16 may be moved to the partially opened position based on an operation of a propulsion system of the vehicle (e.g., an internal combustion engine or an electrically powered propulsion system) being adjusted to an on state. Further, the hood 16 may be moved to the partially opened state based on an operation of a transmission of the vehicle, such as the vehicle being adjusted from a parking gear to a drive gear or a reverse gear.

Accordingly, when the vehicle 10 is not being driven, such as when the vehicle is parked, the hood 16 can remain in its fully closed position, the headlamp 20 system and the side imaging system 22 can remain concealed (or at least partially concealed) by the hood 16, thereby being protected against damage and environmental elements, such as ice and snow. When desired, such as when the vehicle 10 is being driven, the hood and viewing system is automatically placed in use via the hood 16 being automatically moved to its partially opened position in response to a signal from the control unit, thereby exposing the headlamp system 20 to illuminate an environment in front of the vehicle 10, and exposing the side imaging system 22, thereby allowing the driver to see an environment along the opposite sides of the vehicle 10 and to the rear of the vehicle 10. In such a configuration, the headlamp system 20 and side imaging system 22 are revealed to be visible to a user positioned at an exterior of the vehicle. The hood and viewing system is automatically placed in use for example in response to detecting an operating state change of the vehicle such as (i) an operation of a vehicle lighting system (ii) an operation of an internal combustion engine, (iii) an operation of an electric vehicle propulsion system and/or (iv) an operation of a transmission system of the vehicle.

The closure latch assembly includes a ratchet, a primary pawl, and optionally a secondary pawl. The ratchet is movable between a primary closed position, also referred to as primary striker capture position, a secondary closed position, also referred to as secondary striker capture position, and an opened position, also referred to as striker release position, in response to selective movement of the primary and secondary pawls from ratchet retaining positions to ratchet releasing positions. In the primary and secondary closed positions, the ratchet prevents the withdrawal of the striker 18, thereby keeping the hood 16 from being moved to its fully opened position. When in the primary closed position, the ratchet holds the striker 18 relatively deeper within a slot, commonly referred to as a fishmouth of the housing, where the hood 16 is in a fully closed position, as compared to when the ratchet is in the secondary closed position, where the hood 16 is in a partially opened position, but prevented from being moved to the fully opened position by ratchet. With the hood 16 in the partially opened position and the closed position, a user would not be able to gain access to the compartment area 14 as a gap between the hood 16 and the vehicle body 12 would be too small to pass an arm therethrough, and due to the presence of a seal member 42 which may be in contact between the vehicle body 12 and the hood 16. Thus, in the primary closed position the ratchet holds the striker 18 at a first depth in the fishmouth whereat the hood 16 is in a fully closed position, and in the secondary closed position the ratchet holds the striker 18 at a second depth in the fishmouth of the housing whereat the hood 16 is in the partially opened, pop-up position, wherein the first depth is greater than the second depth. The hood 16 may be spring biased from the closed position toward the opened position, such that the hood 16 automatically moves from the closed position to the partially opened position when the ratchet is released from the primary closed position to the secondary closed position. A motor may be operable to draw the ratchet from the secondary closed position to the primary closed position to move the hood 16 from the partially closed position to the fully closed position.

As shown in FIG. 1B, the headlamp system 20 and the side viewing system 22 are disposed at the vehicle body 12 such that the headlamp system 20 and the side viewing system 22 are non-operable and hidden or covered by the hood 16 in the closed position and are operable and exposed or accessible when the hood 16 is in the partially opened position. The headlamp system 20 includes at least one headlamp, which could extend substantially across the front of the vehicle 10, with the headlamp system 20 shown as including a pair of headlamps 24. The headlamp system 20 is concealed from view beneath the hood 16 when the hood 16 is in the fully closed position (FIGS. 1A, 2A and 2B), such as when the vehicle 10 is parked and/or not running. The headlamp system 20 is exposed to allow the headlamps 24 to illuminate the environment in front of the vehicle 10 when the hood 16 is in the partially opened position, such as when the vehicle 10 is running and/or being driven. In other words, with the hood 16 in the closed position, the hood 16 extends at least partially over and along the headlamps 24 to hide or render covert the headlamps 24. In the illustrated example, a forward edge portion of the hood 16 is disposed adjacent to an edge portion of a vehicle body panel disposed beneath the headlamps 24 (e.g., a front bumper or front fascia of the vehicle) (FIG. 1A). With the hood 16 in the partially opened position, the hood 16 is moved away from the headlamps 24 to expose the headlamps 24 such that, when operated, light emitted by the headlamps 24 illuminate the environment at least forward of the vehicle 10. With the hood 16 in the partially opened position, the headlamps 24 are positioned between the forward edge portion of the hood 16 and the edge portion of the vehicle body panel (FIG. 1B). The headlamps 24 may include daylight running lamps, low beam headlamps, high beam headlamps, turn signal indicators, an aesthetic light (e.g., a side marker, ground illumination, etc.) and the like.

Accordingly, permanent external headlights may be replaced with concealable, low profile light sources. This may reduce the size of the light housing or lens for the headlamps and reduces the exposure of the lens to environmental elements as the lights are protected from, for example, rain, ice and snow, when the vehicle 10 is parked and the hood 16 is in the closed position. Additionally, this provides an aesthetically pleasing, minimalistic appearance for the vehicle.

The side imaging system 22 includes at least one sensor device, illustrated as a pair of side cameras 26 as optical imaging devices. The side imaging system 22 is concealed from view beneath the hood 16 when the hood 16 is in the fully closed position, thereby being protected against damage and exposure to environmental elements, such as ice and snow. Then, when desired, such as when the vehicle 10 is running and/or being driven, the side imaging system 22 is deployed, also referred to as exposed, to allow the pair of side cameras 26 to be automatically extended laterally outwardly from beneath the hood 16 in response to a signal from the control unit to capture and present views of a side environment along opposite sides of the vehicle 10 and behind the vehicle 10 to a driver when the hood 16 is in the partially opened position.

That is, and referring to FIG. 1 B, the side imaging system 22 includes a pair of cameras 26 that view rearward of the vehicle 10 and along opposing sides of the vehicle 10. The cameras 26 may be mounted on respective camera wings or posts or arms or shark fins that are pivotably or extendably mounted at the side of the vehicle 10. With the hood 16 in the closed position, the camera wings are pivoted in toward the side of the vehicle 10 to a folded position and are disposed beneath or covered by the hood 16. With the hood 16 moved to the partially opened position, a gap is created between the hood 16 and body panels at the sides of the vehicle 10 and the camera wings are pivoted outward from the side of the vehicle 10 and outboard of the hood 16 to an extended position where the cameras 26 view rearward and along the sides of the vehicle 10. Optionally, the cameras 26 are disposed at posts or arms that extend and retract relative to the side of the vehicle. Image data captured by the cameras 26 may be processed to provide video images representative of a view provided by a traditional exterior rearview mirror at the side of the vehicle. The cameras may utilize characteristics of the cameras and vision systems described in U.S. Pat. Nos. 12,528,424 and/or 11,708,035 and/or U.S. Pat. Pub. No. 2025-0282293, which are hereby incorporated herein by reference in their entireties.

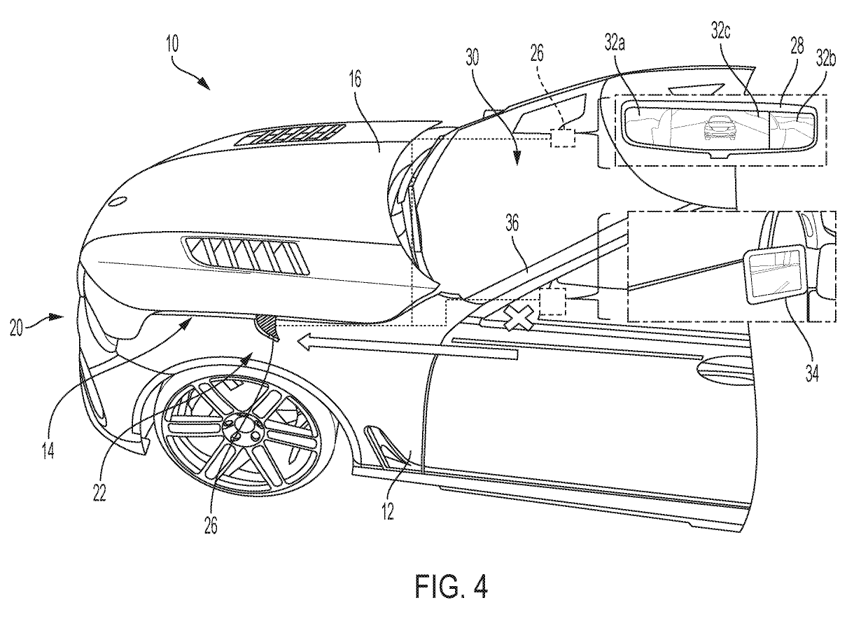

The side imaging system 22 can be arranged in operable communication with a monitor, also referred to as screen, viewable by the driver. The screen can be provided as an interior rearview mirror 28 within a passenger cabin 30 of the motor vehicle 10, with the rearview mirror 28 being arranged in operable communication with the side cameras 26 to present the opposite side views of the side environments along the vehicle 10 to opposite sides 32a, 32b (FIG. 4) of the rearview mirror 28, with the driver being able to readily view the images on the opposite sides 32a, 32b of the rearview mirror 28, with a central portion 32c of the rearview mirror 28 being used by the driver in typical fashion to view straight back through a rear window. In other words, the rearview mirror assembly 28 includes a video display screen operable to display video images for viewing by the driver. When displaying video images for viewing by the driver, the central portion 32c of the display of the rearview mirror assembly 28 may show the view rearward of the vehicle (e.g., based on image data captured by a rearward viewing camera of the vehicle or provided by a mirror reflective element of the mirror assembly 28), one side 32a of the display of the rearview mirror assembly 28 shows the view rearward and along one side of the vehicle (based on image data captured by one of the cameras 26) and the other side 32b of the display of the rearview mirror assembly 28 shows the view rearward along the other side other side of the vehicle (based on image data captured by the other one of the cameras 26).

Further, in addition to, or in lieu of, the rearview mirror 28, a viewing screen 34 can be provided along an A-pillar 36 of the motor vehicle 10, with the viewing screen 34 being arranged in operable communication with the side cameras 26 to present the views of the side environment along the opposite sides of the motor vehicle 10 to the driver in the viewing screen 34. That is, one display screen 34 may be disposed at one A-pillar 36 of the vehicle 10 and shows the view rearward and along one side of the vehicle (based on image data captured by one of the cameras 26) and another display screen 34 is disposed at another A-pillar 36 at the opposing side of the vehicle 10 and shows the view rearward along the other side other side of the vehicle (based on image data captured by the other one of the cameras 26). For example, the A-pillar display device may utilize characteristics of the vision systems described in U.S. Pat. No. 10,960,822 and/or U.S. Publication. Nos. US-2022-0363194; US-2018-0134217 and/or US-2014-0285666 and/or U.S. Patent Application Ser. No. 19/467,948, filed Feb. 3, 2026 (Attorney Docket DON01 P5519) and/or aspects of the vehicle vision systems described in U.S. Publication Nos. US-2025- 0115215; US-2024-0190350 and/or US-2023-0211740, which are hereby incorporated herein by reference in their entireties.

Thus, use of the side imaging system 22 may eliminate the need for a permanent external side view mirror and provides a streamlined, more aerodynamic appearance for the vehicle. The use of a deployable arm or post carrying the cameras 26 reduces drag when the vehicle is driving and increases the blind spot field of view. Additionally, the camera is protected from elements when the vehicle 10 is parked and the hood 16 is in the closed position as the camera mirror and headlights are concealed, providing protection from environmental elements like ice, snow, vandalism, sun damage, and the like. Eliminating the mirror element and required large housing may reduce production complexity and costs.

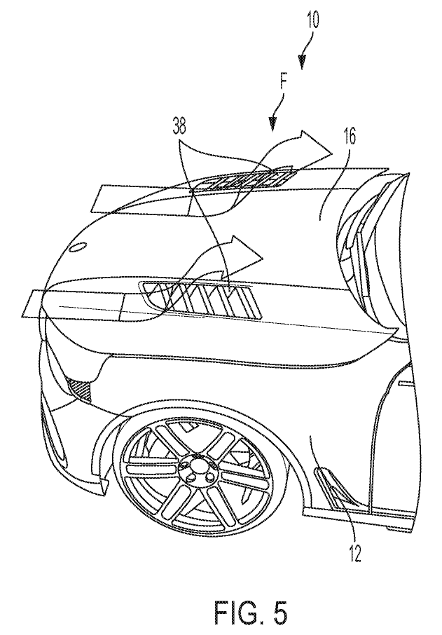

As shown in FIG. 5, the hood and viewing system may include an internal airfoil, also referred to as an internal wing beneath the hood 16, such that a downward thrust F is generated at or near or on the hood 16 to facilitate maintaining the hood 16 in the partially opened position. The flow of air is shown entering beneath a front region of the hood 16 and then exiting through vent slots 38 of the hood 16 to generate the downward thrust F.

In other words, because the hood 16 may be in the partially opened position during driving of the vehicle 10, airflow may pass between the hood 16 and the body panels of the vehicle 10 at the front of the vehicle 10. To prevent this airflow from lifting up the hood 16 (e.g., placing stress on the striker 18 and latch), and to improve drivingdynamics, vent slots 38 formed through the hood 16 may direct the airflow from between the hood 16 and front compartment 14 and upward away from the hood 16, thus generating downward thrust F at the front portion of the vehicle 10. Baffling and sealing may reduce noise generated by the airflow.

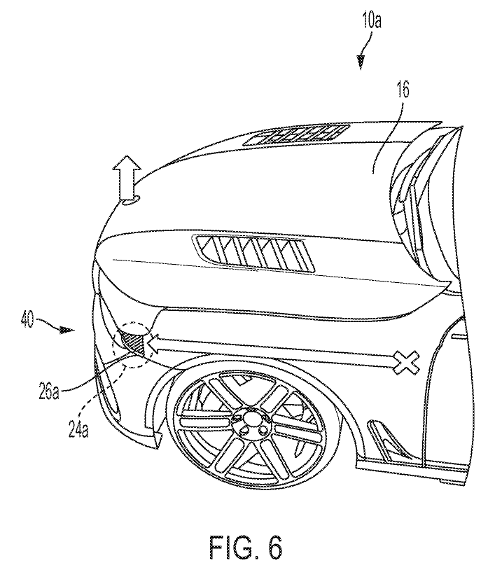

As shown in FIG. 6, the hood and viewing system includes a combination headlamp system and side imaging system integrated into a single viewing assembly 40. As such, the viewing assembly 40 includes a headlamp 24a and a side camera 26a integrated into a single region of a vehicle 10a, shown as at opposite front corner regions of the vehicle 10a. As such, the headlamp 24a is positioned for shining light forward to illuminate the environment forward of the vehicle 10a, while the side camera 26a is positioned to extend laterally to the side of the front corner, thereby being able to image the side region and rearward of the vehicle 10a. In this non-limiting embodiment, the hood 16 may be lifted to the partially opened position at the front region of the hood 16, such as via the latch assembly or otherwise. That is, a front portion or region of the hood 16 lifts relative to the vehicle body 12 while a rear portion or region of the hood 16 (e.g., disposed adjacent to the windshield of the vehicle) does not lift relative to the vehicle body 12 or lifts relative to the vehicle body 12 to a lesser degree than the front portion (e.g., via pivoting of the hood 16).

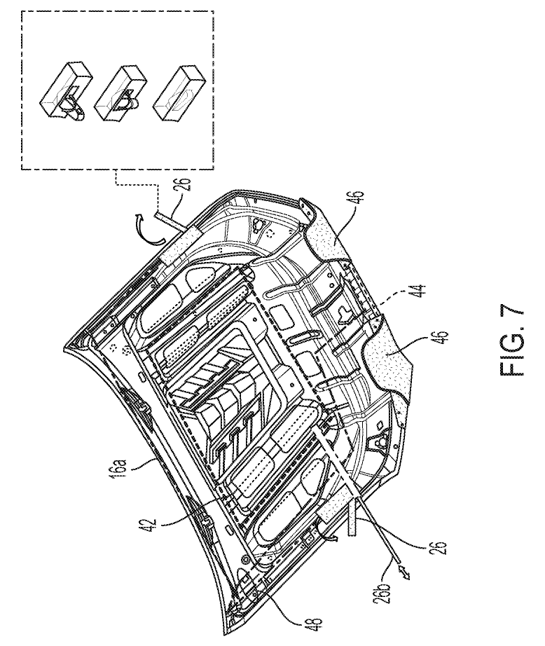

As shown in FIG. 7, a hood 16a may include the seal member 42 for sealing internal airfoils or wings, such as shown in FIG. 5. The hood 16a may further include the sensor disposed on an extendable member, such as for example a telescopic camera 26b, with the telescopic camera 26b able to extend telescopically laterally outwardly from the vehicle body 12 to an extent sufficient to view around a wide load, such as a trailer, by way of example and without limitation. In other words, the extendable camera 26b may be extendable to a first position view rearward and along the side of the vehicle 10 and the extendable camera 26b may extend further to a second position to view from a different viewpoint rearward and along the side of the vehicle, such as when the vehicle 10 is in a towing mode and towing a trailer. Further, the hood 16a may include a running daylight array 44 mounted to an underside of the hood 16a. Further, headlamp shades 46 having any desired pattern, color, and made of a suitable material, such as stamped sheet metal or molded plastic, may be mounted to the underside of the hood 16a to produce the desired light pattern from the headlamps 24. Further yet, side cameras 26 may be mounted to the underside of the hood 16a for motorized deployment laterally outwardly therefrom upon the hood 16a being raised to the partially opened position. Accordingly, the hood 16a may be constructed as an all-inclusive module complete for shipping to an assembly facility, whereat plug-and-play electrical connections can be made via an integrated wire harness 48 fixed to the underside of the hood 16a.

Thus, the vehicular hood and viewing system provides a hidden, compact lighting source or headlamp 24 that opens up new styling options and packaging savings. Additionally, the camera system 22 improves blind spot detection and eliminates bulky exterior rearview mirrors.

The partially opened position of the hood 16 may be an intermediate hood position between the primary closed or active position and the fully opened or pedestrian position. When the hood 16 is deployed, the hood 16 raises to deploy the lights 24 (e.g., daytime, low beam, high beam, and the like) and the extendable camera 26 (e.g., mounted on a shark fin). The camera signal may be fed back to the interior rearview mirror assembly display screen and/or a video display screen on the A-pillar of the vehicle. Moving the camera 26 forward (e.g., from the position of a traditional exterior rearview mirror) increases the blind spot field of view, as well as eliminates a forward blind spot otherwise created by the traditional exterior rearview mirror.

In some examples, a front portion of the hood 16 is raised when the hood 16 is moved to the partially opened position, and side portions of the hood 16 do not lift substantially from the closed position to the partially opened position. Thus, the headlamps 24 and the cameras 26 are disposed at the forward portion of the vehicle 10 to be exposed when the hood 16 moves to the partially opened position. Additionally, the frunk 14 may be sealed when the hood 16 is in the partially opened position, with baffling and aerostructures directing airflow to generate downward force F while reducing noise. The camera 26 may be telescopically extended from beneath the hood 16, such as to extend the field of view when the vehicle 10 is towing a trailer.

Although described herein as a front cover panel or hood, it should be understood that aspects of the disclosure may be suitable for use with other cover panels at the vehicle, such as a rear cover panel like a trunk or liftgate or tailgate of the vehicle. The rear cover panel may conceal brake lights or reverse lights or turn signal indicators in the closed position and reveal the rear lights of the vehicle when in the partially opened position. Further, the rear cover panel may conceal rearward sensing vehicle sensors, like a rearward viewing camera or backup camera, parking sensors, and the like. The sensors may be exposed with the rear cover panel in the partially opened position to allow the sensors to sense exterior the vehicle and at least rearward of the vehicle.

According to an aspect of the disclosure, a vehicle includes a vehicle body and a motor bay or compartment area defined by the vehicle body. For example, the motor bay may house a motor of the vehicle. At least one lighting device is supported on the vehicle body. A hood is movable relative to the vehicle body. The hood has a closed position to fully enclose the motor bay and to at least partially conceal the at least one lighting device from being visible exterior the vehicle, and the hood has a partially opened position to partially enclose the motor bay and to reveal the at least one lighting device to be visible exterior the vehicle, and the hood has a fully opened position to allow access to the motor.

According to another aspect of the disclosure, a vehicular cover panel opening system for a vehicle having a vehicle body supporting at least one lighting device and a cover panel associated with a compartment of the vehicle body. The system includes a latching arrangement configured to maintain the cover panel in a closed position relative to the vehicle body and to release the cover panel to allow the cover panel to move relative to the vehicle body. The system further includes a hinge arrangement configured to allow the cover panel to move relative to the vehicle body. The at least one of the hinge arrangement and the latching arrangement facilitate movement of the cover panel from the closed position, where the at least one lighting device is at least partially concealed when the vehicle is viewed from an exterior position to the vehicle, to a partially opened position, where the at least one lighting device is at least partially visible when the vehicle is viewed from the exterior position to the vehicle.

The hood and viewing system may utilize characteristics of the cover panel opening systems described in U.S. Pat. Pub. No. US-2025-0388269, which is incorporated herein by reference in its entirety.

The camera or sensor may comprise any suitable camera or sensor. Optionally, the camera may comprise a "smart camera" that includes the imaging sensor array and associated circuitry and image processing circuitry and electrical connectors and the like as part of a camera module, such as by utilizing aspects of the vision systems described in U.S. Pat. Nos. 10,099,614 and/or 10,071,687, which are hereby incorporated herein by reference in their entireties.

The system includes an image processor operable to process image data captured by the camera or cameras, such as for detecting objects or other vehicles or pedestrians or the like in the field of view of one or more of the cameras. For example, the image processor may comprise an image processing chip selected from the EYEQ family of image processing chips available from Mobileye Vision Technologies Ltd. of Jerusalem, Israel, and may include object detection software (such as the types described in U.S. Pat. Nos. 7,855,755; 7,720,580 and/or 7,038,577, which are hereby incorporated herein by reference in their entireties), and may analyze image data to detect vehicles and/or other objects. Responsive to such image processing, and when an object or other vehicle is detected, the system may generate an alert to the driver of the vehicle and/or may generate an overlay at the displayed image to highlight or enhance display of the detected object or vehicle, in order to enhance the driver's awareness of the detected object or vehicle or hazardous condition during a driving maneuver of the equipped vehicle.

The vehicle may include any type of sensor or sensors, such as imaging sensors or radar sensors or lidar sensors or ultrasonic sensors or the like. The imaging sensor of the camera may capture image data for image processing and may comprise, for example, a two-dimensional array of a plurality of photosensor elements arranged in at least 640 columns and 480 rows (at least a 640 x 480 imaging array, such as a megapixel imaging array or the like), with a lens focusing images onto the imaging array. The photosensor array may comprise a plurality of photosensor elements arranged in a photosensor array having rows and columns. The imaging array may comprise a CMOS imaging array having at least 300,000 photosensor elements or pixels, preferably at least 500,000 photosensor elements or pixels and more preferably at least one million photosensor elements or at least two million photosensor elements or pixels or at least three million photosensor elements or pixels or at least five million photosensor elements or pixels arranged in rows and columns. The imaging array may be sensitive to near-infrared light. The imaging array may capture color image data, such as via spectral filtering at the array, such as via an RGB (red, green and blue) filter or via a red / red complement filter or such as via an RCC (red, clear, clear) filter or the like. The logic and control circuit of the imaging sensor may function in any known manner, and the image processing and algorithmic processing may comprise any suitable means for processing the images and/or image data.

For example, the vision system and/or processing and/or camera and/or circuitry may utilize aspects described in U.S. Pat. Nos. 9,233,641; 9,146,898; 9,174,574; 9,090,234; 9,077,098; 8,818,042; 8,886,401; 9,077,962; 9,068,390; 9,140,789; 9,092,986; 9,205,776; 8,917,169; 8,694,224; 7,005,974; 5,760,962; 5,877,897; 5,796,094; 5,949,331; 6,222,447; 6,302,545; 6,396,397; 6,498,620; 6,523,964; 6,611,202; 6,201,642; 6,690,268; 6,717,610; 6,757,109; 6,802,617; 6,806,452; 6,822,563; 6,891,563; 6,946,978; 7,859,565; 5,550,677; 5,670,935; 6,636,258; 7,145,519; 7,161,616; 7,230,640; 7,248,283; 7,295,229; 7,301,466; 7,592,928; 7,881,496; 7,720,580; 7,038,577; 6,882,287; 5,929,786 and/or 5,786,772, and/or U.S. Publication Nos. US-2014-0340510; US-2014-0313339; US-2014- 0347486; US-2014-0320658; US-2014-0336876; US-2014-0307095; US-2014-0327774; US-2014-0327772; US-2014-0320636; US-2014-0293057; US-2014-0309884; US-2014- 0226012; US-2014-0293042; US-2014-0218535; US-2014-0218535; US-2014-0247354; US-2014-0247355; US-2014-0247352; US-2014-0232869; US-2014-0211009; US-2014- 0160276; US-2014-0168437; US-2014-0168415; US-2014-0160291; US-2014-0152825; US-2014-0139676; US-2014-0138140; US-2014-0104426; US-2014-0098229; US-2014- 0085472; US-2014-0067206; US-2014-0049646; US-2014-0052340; US-2014-0025240; US-2014-0028852; US-2014-005907; US-2013-0314503; US-2013-0298866; US-2013- 0222593; US-2013-0300869; US-2013-0278769; US-2013-0258077; US-2013-0258077; US-2013-0242099; US-2013-0215271; US-2013-0141578 and/or US-2013-0002873, which are all hereby incorporated herein by reference in their entireties. The system may communicate with other communication systems via any suitable means, such as by utilizing aspects of the systems described in U.S. Pat. Nos. 10,071,687; 9,900,490; 9,126,525 and/or 9,036,026, which are hereby incorporated herein by reference in their entireties.

Optionally, the vision system may include a display for displaying images captured by one or more of the imaging sensors for viewing by the driver of the vehicle while the driver is normally operating the vehicle. Optionally, for example, the vision system may include a video display device, such as by utilizing aspects of the video display systems described in U.S. Pat. Nos. 5,530,240; 6,329,925; 7,855,755; 7,626,749; 7,581,859; 7,446,650; 7,338,177; 7,274,501; 7,255,451; 7,195,381; 7,184,190; 5,668,663; 5,724,187; 6,690,268; 7,370,983; 7,329,013; 7,308,341; 7,289,037; 7,249,860; 7,004,593; 4,546,551; 5,699,044; 4,953,305; 5,576,687; 5,632,092; 5,708,410; 5,737,226; 5,802,727; 5,878,370; 6,087,953; 6,173,501; 6,222,460; 6,513,252 and/or 6,642,851, and/or U.S. Publication Nos. US-2014-0022390; US-2012-0162427; US-2006-0050018 and/or US- 2006-0061008, which are all hereby incorporated herein by reference in their entireties.

Optionally, the display may be viewable through a reflective element of a mirror assembly when the display is activated to display information. Optionally, the display element may comprise any type of display element, such as a vacuum fluorescent (VF) display element, a light emitting diode (LED) display element, such as an organic light emitting diode (OLED) or an inorganic light emitting diode, an electroluminescent (EL) display element, a liquid crystal display (LCD) element, a video screen display element or backlit thin film transistor (TFT) display element or the like, and may be operable to display various information (as discrete characters, icons or the like, or in a multi-pixel manner) to the driver of the vehicle, such as passenger side inflatable restraint (PSIR) information, tire pressure status, and/or the like.

The display device may be disposed at or incorporated in an interior mirror assembly, and the interior mirror assembly may comprise a dual-mode interior rearview video mirror that can switch from a traditional reflection mode to a live-video display mode, such as by utilizing aspects of the mirror assemblies and systems described in U.S. Pat. Nos. 10,442,360; 10,421,404; 10,166,924 and/or 10,046,706, and/or U.S. Publication Nos. US-2021-0323473; US-2021-0245662; US-2021-0162926; US-2021-0155167; US-2021- 0094473; US-2020-0377022; US-2019-0258131; US-2019-0146297; US-2019-0118717; US-2019-0047475 and/or US-2017-0355312, which are all hereby incorporated herein by reference in their entireties.

The sideward and/or rearward facing imaging sensor or camera that has a sideward/rearward field of view at the side of the vehicle may be part of or may provide an image output for a vehicle vision system, such as a lane departure warning system or object detection system or blind zone alert system or surround view vision system other vehicle vision system or the like, and may utilize aspects of various imaging sensors or imaging array sensors or cameras or the like, such as a CMOS imaging array sensor, a CCD sensor or other sensors or the like, such as the types described in U.S. Pat. Nos. U.S. Pat. Nos. 5,550,677; 5,670,935; 5,760,962; 6,498,620; 6,396,397; 6,222,447; 6,201,642; 6,097,023; 5,877,897; 5,796,094; 5,715,093; 6,922,292; 6,757,109; 6,717,610; 6,590,719; 6,320,176; 6,559,435; 6,831,261; 6,806,452; 6,822,563; 6,946,978; 7,038,577; 7,004,606 and/or 7,720,580, which are all hereby incorporated herein by reference in their entireties.

The terminology used herein is for the purpose of describing particular example embodiments only and is not intended to be limiting. As used herein, the singular forms "a," "an," and "the" may be intended to include the plural forms as well, unless the context clearly indicates otherwise. The terms "compromises," "comprising," "including," and "having," are inclusive and therefore specify the presence of stated features, integers, steps, operations, elements, and/or components, but do not preclude the presence or addition of one or more other features, integers, steps, operations, elements, and/or components, but do not preclude the presence or addition of one or more other features, integers, steps operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being "on," "engaged to," "connected to," or "coupled to" another element or layer, it may be directly on, engaged, connected or coupled to the other element or layer, or intervening elements or layers may be present. In contrast, when an element is referred to as being "directly on," directly engaged to," "directly connected to," or "directly coupled to" another element or layer, there may be no intervening elements or layers present. Other words used to describe the relationship between elements should be interpreted in a like fashion (e.g., "between" versus "directly between," "adjacent" versus "directly adjacent," etc.). As used herein, the term "and/or" includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as "first," "second," and other numerical terms when used herein do not imply a sequence or order unless clearly indicated by thecontext. Thus, a first element, component, region, layer or section discussed below could be termed a second element, component, region, layer or section without departing from the teachings of the example embodiments.

Spatially relative terms, such as "inner," "outer," "beneath," "below," "lower," "above," "upper," and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as "below" or "beneath" other elements or features would then be oriented "above" the other elements or features. Thus, the example term "below" can encompass both an orientation of above and below. The device may be otherwise oriented (rotated 90 degrees or at other orientations) and the spatially relative descriptors used herein interpreted accordingly.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.Changes and modifications in the specifically described embodiments may be carried out without departing from the principles of the present invention, which is intended to be limited only by the scope of the appended claims as interpreted according to the principles of patent law.

1. A vehicular cover panel opening system, the vehicular cover panel opening system comprising:a hinge assembly configured to pivotably mount a cover panel at a compartment area of a vehicle equipped with the vehicular cover panel opening system;wherein, with the cover panel mounted at the compartment area of the vehicle, the cover panel is movable between (i) a closed position where the cover panel covers an opening of the compartment area of the vehicle, (ii) an opened position where the cover panel is moved away from the opening of the compartment area to allow access to the compartment area and (iii) a partially opened position between the closed position and the opened position;a latch assembly that, with the cover panel mounted at the compartment area of the vehicle, is configured to (i) secure the cover panel in the closed position and (ii) release the cover panel to allow the cover panel to move from the closed position or the partially opened position;wherein, with the cover panel mounted at the compartment area of the vehicle, and with the cover panel in the closed position, the vehicular cover panel opening system is operable to control the latch assembly to release the cover panel;wherein, with the cover panel mounted at the compartment area of the vehicle, and when the vehicular cover panel opening system operates the latch assembly to release the cover panel, the cover panel moves from the closed position to the partially opened position;wherein the vehicle comprises at least one lighting device;wherein, with the cover panel mounted at the compartment area of the vehicle, and with the cover panel in the closed position, the cover panel extends over and along the at least one lighting device to conceal the at least one lighting device from view; andwherein, with the cover panel mounted at the compartment area of the vehicle, and with the cover panel at least in the partially opened position, and when the at least one lighting device is electrically operated to emit light, light emitted by the at least one lighting device is viewable exterior the vehicle.

2. The vehicular cover panel opening system of claim 1, wherein the latch assembly comprises a ratchet disposed at a body of the vehicle, and wherein, with the cover panel mounted at the compartment area of the vehicle, and with the cover panel in the closed position, the ratchet is in a striker capture position where the ratchet retains a striker fixed to the cover panel, and with the cover panel in the partially opened position, the ratchet retains the striker fixed to the cover panel, and with the cover panel in the opened position, the ratchet releases the striker to allow the cover panel to move relative to the body of the vehicle.

3. The vehicular cover panel opening system of claim 1, wherein, with the cover panel mounted at the compartment area of the vehicle, the vehicular cover panel opening system operates the latch assembly to move the cover panel from the closed position to the partially opened position in response to an operating state change of the vehicle, and wherein the operating state change of the vehicle comprises one selected from the group consisting of (i) an operation of a lighting system of the vehicle, (ii) an operation of an internal combustion engine of the vehicle, (iii) an operation of an electric propulsion system of the vehicle and (iv) an operation of a transmission of the vehicle.

4. The vehicular cover panel opening system of claim 1, wherein the hinge assembly comprises a hinge that, with the cover panel mounted at the compartment area of the vehicle, is mounted to the cover panel and a body of the vehicle, and wherein the hinge is adjustable between (i) a collapsed state corresponding to the cover panel being in the closed position, (ii) an expanded state corresponding to the cover panel being in the opened position and (iii) a deployed state corresponding to the cover panel being in the partially opened position.

5. The vehicular cover panel opening system of claim 4, wherein, with the cover panel mounted at the compartment area of the vehicle, and with the hinge in the collapsed state and the cover panel in the closed position, the latch assembly secures the cover panel relative to the body of the vehicle, and with the hinge in the expanded state and the cover panel in the opened position, the latch assembly releases the cover panel to allow the cover panel to move relative to the body of the vehicle, and with the hinge in the deployed 26
state and the cover panel in the partially opened position, the latch assembly secures the cover panel relative to the body of the vehicle.

6. The vehicular cover panel opening system of claim 4, wherein the latch assembly is disposed at a first side portion of the cover panel, and wherein the hinge is disposed at a second side portion of the cover panel opposite the first side portion, and wherein, with the cover panel mounted at the compartment area of the vehicle, the latch assembly and the first side portion of the cover panel are disposed at a front end region of the body of the vehicle and the hinge and the second side portion of the cover panel are disposed at the body of the vehicle and adjacent to a windshield of the vehicle.

7. The vehicular cover panel opening system of claim 6, wherein, with the cover panel mounted at the compartment area of the vehicle, and when the hinge is adjusted between the collapsed state and the deployed state, the cover panel translates relative to the body of the vehicle, and when the hinge is adjusted between the deployed state and the expanded state, the cover panel pivots relative to the body of the vehicle.

8. The vehicular cover panel opening system of claim 4, wherein the hinge assembly comprises an electrically operable actuator that operates to adjust the hinge between the collapsed state, the deployed state and the expanded state.

9. The vehicular cover panel opening system of claim 1, wherein the latch assembly comprises an electrically operable actuator that operates to move the cover panel between the closed position, the partially opened position and the opened position.

10. The vehicular cover panel opening system of claim 1, wherein the vehicle comprises a sensor, and wherein, with the cover panel mounted at the compartment area of the vehicle, and with the cover panel in the closed position, the sensor is concealed from view beneath the cover panel, and wherein, with the cover panel mounted at the compartment area of the vehicle, and with the cover panel in the partially opened position, the sensor is exposed and senses exterior of the vehicle.

11. The vehicular cover panel opening system of claim 10, wherein, with the cover panel mounted at the compartment area of the vehicle, and with the cover panel in the partially opened position, a gap is formed between the cover panel and a body of the vehicle and the sensor senses exterior of the vehicle through the gap.

12. The vehicular cover panel opening system of claim 10, wherein the sensor comprises a driver-side camera and a passenger-side camera, and wherein, with the cover panel mounted at the compartment area of the vehicle, and with the cover panel in the closed position, the driver-side camera and the passenger-side camera are concealed from view, and wherein, with the cover panel mounted at the compartment area of the vehicle, and with the cover panel in the partially opened position, (i) the driver-side camera views exterior of the vehicle and at least rearward of the vehicle and along a driver side of the vehicle and (ii) the passenger-side camera views exterior of the vehicle and at least rearward of the vehicle and along a passenger side of the vehicle.

13. The vehicular cover panel opening system of claim 12, wherein the driver-side camera is disposed at a driver-side wing that is pivotably disposed at the vehicle, and wherein the driver-side camera is disposed at a passenger-side wing that is pivotably disposed at the vehicle, and wherein, with the cover panel mounted at the compartment area of the vehicle, and with the cover panel in the closed position, the driver-side wing and the passenger-side wing are in a folded position, where the driver-side wing is pivoted in toward the driver side of the vehicle and the passenger-side wing is pivoted in toward the passenger side of the vehicle, and with the cover panel in the partially opened position, the driver-side wing and the passenger-side wing are in an extended position, where the driver-side wing is pivoted out from the driver side of the vehicle and the passenger-side wing is pivoted out from the passenger side of the vehicle.

14. The vehicular cover panel opening system of claim 1, wherein the at least one lighting device comprises at least one selected from the group consisting of (i) a daylight running lamp, (ii) a high beam lamp, (iii) a low beam lamp, (iv) a turn signal indicator lamp,
(v) a brake light, (vi) a reverse light and (vii) an aesthetic light.

15. The vehicular cover panel opening system of claim 1, wherein the cover panel comprises a seal that, with the cover panel mounted at the compartment area of the vehicle, and with the cover panel in the opened position or in the partially opened position, seals the opening of the compartment area.

16. The vehicular cover panel opening system of claim 1, wherein the cover panel comprises a vent, and wherein, with the cover panel mounted at the compartment area of the vehicle, and with the cover panel in the partially opened position and as the vehicle travels in a forward direction of travel, airflow that passes between the cover panel and a body of the vehicle is directed through the vent and upward away from the cover panel, and wherein a downward force is applied at a front portion of the vehicle as the airflow is directed through the vent and upward away from the cover panel.

17. The vehicular cover panel opening system of claim 1, wherein the compartment area comprises one selected from the group consisting of (i) an engine bay of the vehicle and (ii) a forward cargo area of the vehicle.

18. A vehicular cover panel opening system, the vehicular cover panel opening system comprising:a hinge assembly configured to pivotably mount a cover panel at a compartment area of a vehicle equipped with the vehicular cover panel opening system;wherein, with the cover panel mounted at the compartment area of the vehicle, the cover panel is movable between (i) a closed position where the cover panel covers an opening of the compartment area of the vehicle, (ii) an opened position where the cover panel is moved away from the opening of the compartment area to allow access to the compartment area and (iii) a partially opened position between the closed position and the opened position;a latch assembly that, with the cover panel mounted at the compartment area of the vehicle, is configured to (i) secure the cover panel in the closed position and (ii) release the cover panel to allow the cover panel to move from the closed position;
wherein, with the cover panel mounted at the compartment area of the vehicle, and with the cover panel in the closed position, the vehicular cover panel opening system is operable to control the latch assembly to release the cover panel;
wherein, with the cover panel mounted at the compartment area of the vehicle, and when the vehicular cover panel opening system operates the latch assembly to release the cover panel, the cover panel moves from the closed position to the partially opened position;
wherein the latch assembly comprises a ratchet disposed at a body of the vehicle, and wherein, with the cover panel mounted at the compartment area of the vehicle, and with the cover panel in the closed position, the ratchet is in a striker capture position where the ratchet retains a striker fixed to the cover panel, and with the cover panel in the partially opened position, the ratchet retains the striker fixed to the cover panel, and with the cover panel in the opened position, the ratchet releases the striker to allow the cover panel to move relative to the body of the vehicle;
wherein the vehicle comprises at least one lighting device;
wherein the vehicle comprises a driver-side camera and a passenger-side camera;
wherein, with the cover panel mounted at the compartment area of the vehicle, and with the cover panel in the closed position, (i) the cover panel extends over and along the at least one lighting device to conceal the at least one lighting device from view and (ii) the cover panel extends over the driver-side camera and the passenger-side camera and the driver-side camera and the passenger-side camera are concealed from view; and
wherein, with the cover panel mounted at the compartment area of the vehicle, and with the cover panel in the partially opened position, (i) when the at least one lighting device is electrically operated to emit light, the at least one lighting device is exposed and light emitted by the at least one lighting device is viewable exterior the vehicle, (ii) the driver-side camera is exposed and views exterior of the vehicle and at least rearward of the vehicle and along a driver side of the vehicle and (iii) the passenger-side camera is exposed and views exterior of the vehicle and at least rearward of the vehicle and along a passenger side of the vehicle.

19. The vehicular cover panel opening system of claim 18, wherein, with the cover panel mounted at the compartment area of the vehicle, the vehicular cover panel opening
system operates the latch assembly to move the cover panel from the closed position to the partially opened position in response to an operating state change of the vehicle, and wherein the operating state change of the vehicle comprises one selected from the group consisting of (i) an operation of a lighting system of the vehicle, (ii) an operation of an internal combustion engine of the vehicle, (iii) an operation of an electric propulsion system of the vehicle and (iv) an operation of a transmission of the vehicle.

20. A vehicular cover panel opening system, the vehicular cover panel opening system comprising:a hinge assembly configured to pivotably mount a cover panel at a compartment area of a vehicle equipped with the vehicular cover panel opening system;wherein, with the cover panel mounted at the compartment area of the vehicle, the cover panel is movable between (i) a closed position where the cover panel covers an opening of the compartment area of the vehicle, (ii) an opened position where the cover panel is moved away from the opening of the compartment area to allow access to the compartment area and (iii) a partially opened position between the closed position and the opened position;a latch assembly that, with the cover panel mounted at the compartment area of the vehicle, is configured to (i) secure the cover panel in the closed position and (ii) release the cover panel to allow the cover panel to move from the closed position;a seal that, with the cover panel mounted at the compartment area of the vehicle, and with the cover panel in the opened position or in the partially opened position, seals the opening of the compartment area;wherein, with the cover panel mounted at the compartment area of the vehicle, and with the cover panel in the closed position, the vehicular cover panel opening system is operable to control the latch assembly to release the cover panel;wherein, with the cover panel mounted at the compartment area of the vehicle, and when the vehicular cover panel opening system operates the latch assembly to release the cover panel, the cover panel moves from the closed position to the partially opened position;wherein the latch assembly comprises a ratchet disposed at a body of the vehicle, and wherein, with the cover panel mounted at the compartment area of the vehicle, and
with the cover panel in the closed position, the ratchet is in a striker capture position where the ratchet retains a striker fixed to the cover panel, and with the cover panel in the partially opened position, the ratchet retains the striker fixed to the cover panel, and with the cover panel in the opened position, the ratchet releases the striker to allow the cover panel to move relative to the body of the vehicle;wherein the hinge assembly comprises a hinge that, with the cover panel mounted at the compartment area of the vehicle, is mounted to the cover panel and a body of the vehicle, and wherein the hinge is adjustable between (i) a collapsed state corresponding to the cover panel being in the closed position, (ii) an expanded state corresponding to the cover panel being in the opened position and (iii) a deployed state corresponding to the cover panel being in the partially opened position;wherein the vehicle comprises at least one lighting device;wherein, with the cover panel mounted at the compartment area of the vehicle, and with the cover panel in the closed position, the cover panel extends over and along the at least one lighting device to conceal the at least one lighting device from view; andwherein, with the cover panel mounted at the compartment area of the vehicle, and with the cover panel in the partially opened position, and when the at least one lighting device is electrically operated to emit light, the at least one lighting device is exposed and light emitted by the at least one lighting device is viewable exterior the vehicle.
